(19) United States
(12) Patent Application Publication
(10) Pub. No.: US 2015/0167723 A1
(43) Pub. Date: Jun. 18, 2015

(54) FASTENING ELEMENT AND METHOD FOR MOUNTING SAME

(71) Applicant: Johnson Controls Technology Company, Holland, MI (US)

(72) Inventors: Dustin Flock, Koln (DE); Jörg Jonas, Wulfrath (DE); Carina Laws, Langenfeld (DE); Axel Koever, Koln (DE)

(21) Appl. No.: 14/407,714

(22) PCT Filed: May 3, 2013
(86) PCT No.: PCT/EP2013/059284

§ 371 Date: Dec. 12, 2014

(30) Foreign Application Priority Data
Jun. 13, 2012 (DE) 10 2012 209 934.4
Aug. 13, 2012 (DE) 10 2012 214 395.5

(51) Int. Cl. F16B 39/22

(52) U.S. Cl. CPC F16B 39/22

(57) ABSTRACT

A fastening element (1), for a form-fit, bonded, and/or force-locked arrangement on and/or in a fiber composite component (9), includes a sleeve section (3). At a first end (4) of the sleeve section (3), a holding section (5) is formed, which is angled off the sleeve section (3) such that an outer diameter of the fastening element (1) is enlarged by the holding section (5). A method for mounting is further provided for manufacturing the fastening element (1) on and/or the fiber composite component (9). A fiber composite component (9) manufactured using the method, having at least one fastening element is also provided.

### CROSS REFERENCE TO RELATED APPLICATIONS

This application is a United States National Phase Application of International Application PCT/EP2013/059284 filed May 3, 2013 and claims the benefit of priority under 35 U.S.C. §119 of German Patent Applications DE 10 2012 209 934.4 filed Jun. 13, 2012 and DE 10 2012 214 395.5 filed Aug. 13, 2012, the entire contents of which are incorporated herein by reference.

### FIELD OF THE INVENTION

The invention relates to a fastening element for positive-locking, materially engaging and/or non-positive-locking arrangement on and/or in a composite fiber component, a method for mounting a fastening element on and/or in a composite fiber component and a composite fiber component combination with the fastening element.

### BACKGROUND OF THE INVENTION

In the prior art, connection elements are fitted to composite fiber components by means of screwing, riveting and/or adhesive bonding. Such composite fiber components are, for example, fiber-reinforced thermoplastic plates.

### SUMMARY OF THE INVENTION

An object of the present invention is to provide a fastening element for positive-locking, materially engaging and/or non-positive-locking arrangement on and/or in a composite fiber component, which fastening element is improved with respect to the prior art, a method which is improved with respect to the prior art for mounting a fastening element on and/or in a composite fiber component and a composite fiber component which is improved with respect to the prior art having at least one fastening element.

The object is achieved according to the invention by a fastening element for positive-locking, materially engaging and/or non-positive-locking arrangement on and/or in a composite fiber component, a method for mounting a fastening element on and/or in a composite fiber component and a composite fiber component in combination with a fastening element.

A fastening element according to the invention for positive-locking, materially engaging and/or non-positive-locking arrangement on and/or in a composite fiber component comprises a sleeve-like (sleeve) portion, wherein there is formed at a first end of the sleeve portion a retention portion which is angled away from the sleeve portion in such a manner that an outer diameter of the fastening element is increased by the retention portion. That is to say that the retention portion is angled away from the sleeve portion in such a manner that it projects beyond and thereby increases the outer diameter of the sleeve portion.

The fastening element is intended to be introduced or pressed into the composite fiber component during a mounting method until a second abutment face of the retention portion of the fastening element is in abutment with a first side of the composite fiber component, preferably in abutment in a planar manner. The introduction or pressing-in is advantageously carried out in this instance whilst the fastening element and/or the composite fiber component is heated so that a thermoplastic matrix of the composite fiber component is melted in a pressing-in region and is displaced during the introduction or pressing-in of the fastening element. By means of such a connection, which is enabled by the fastening element which is constructed according to the invention, high forces which occur, for example, in vehicle seats in the event of a crash, can be transmitted. Conventional connection elements must either be incorporated in the composite fiber component in a complex manner during the production process thereof or be arranged in a screwed manner on the composite fiber component with the fibers of the composite fiber component being destroyed by a drilling process. The fastening element according to the invention enables a positive-locking, materially engaging and/or non-positive-locking connection which does not destroy fibers between the fastening element and the composite fiber component, in particular with force transmission between the fastening element and the composite fiber component being significantly improved.

Advantageously, the retention portion is angled substantially at right-angles away from the sleeve portion. In this manner, the retention portion is in planar abutment with the first side of the composite fiber component, at least when the fastening element starting from the first side of the composite fiber component has been introduced or pressed perpendicularly therein. Advantageously, the retention portion forms a planar abutment face in order to enable the most planar and extensive abutment possible with the first side of the composite fiber component.

In an advantageous embodiment, the sleeve portion has an inner thread. In that manner, a screw-like fastening of at least one additional component to the fastening element and thereby to the composite fiber component is thereby enabled. Alternatively, the sleeve portion may also have a through-opening without any inner thread in order, for example, to arrange a screw, a bolt or an axle therein.

The fastening element is preferably formed from a metal material, whereby it is constructed in a sufficiently stable manner to withstand loads which occur during the mounting in the composite fiber component and during a subsequent use of the composite fiber component. Furthermore, the heating of the fastening element to a temperature which is above the melting temperature of the thermoplastic matrix of the composite fiber component is thereby enabled so that in this manner the introduction or pressing-in of the fastening element into the composite fiber component is enabled. Alternatively, it is also possible to use other in particular temperature-resistant materials which withstand the temperatures that are required for introduction or pressing-in, at least for the short introduction or pressing-in time. A combination of metal and another material is also possible.

Advantageously, the fastening element has in the region of the sleeve portion at the outer side a surface structure. A particularly good positive-locking, materially engaging and/or non-positive-locking connection of the fastening element to the composite fiber component is thereby enabled since the fibers and the matrix of the composite fiber component surround the sleeve portion at the outer side and become interlocked in the surface structure. In order to achieve the best possible such interlocking and positive-locking, materially engaging and/or non-positive-locking connection of the fastening element to the composite fiber component, the surface structure is constructed, for example, as a graining and/or corrugation.

In a method according to the invention for mounting such a fastening element on and/or in a composite fiber component, the fastening element is placed in such a positive-locking manner on an at least partially correspondingly constructed joining tool, which has a conical or cone-like portion, that the conical or cone-like portion projects beyond a second end of the fastening element, which end is directed away from the retention portion, in an axial direction of the sleeve portion of the fastening element, the second end of the fastening element is in abutment with a base face of the conical or cone-like portion and a diameter of the base face of the conical or cone-like portion substantially corresponds to an outer diameter of the sleeve portion of the fastening element. The fastening element and the joining tool which is constructed, for example, as a joining mandrel, are then introduced or pressed according to the invention into the composite fiber component in such a manner that the conical or cone-like portion of the joining tool extends completely through the composite fiber component from a first side to a second side and the sleeve portion of the fastening element is introduced into the composite fiber component until a second abutment face of the retention portion of the fastening element is in abutment with a first side of the composite fiber component, preferably in abutment in a planar manner.

By means of such a connection which is enabled by the method according to the invention, high forces which occur, for example, in vehicle seats in the event of a crash, can be transmitted. Conventional connection elements must either be embedded in the composite fiber component in a complex manner during the production process thereof or be arranged on the composite fiber component in a screwed manner with the fibers of the composite fiber component being destroyed by means of a drilling process. The method according to the invention enables a positive-locking, materially engaging and/or non-positive-locking connection which does not destroy fibers between the fastening element and the composite fiber component, a force transmission between the fastening element and composite fiber component in particular being significantly improved.

In an advantageous embodiment, the fastening element and the joining tool are heated to a predeterminable temperature before being introduced or pressed into the composite fiber component and in the heated state are introduced or pressed into the composite fiber component in such a manner that the conical or cone-like portion of the joining tool extends completely through the composite fiber component from the first side to the second side and the sleeve portion of the fastening element is introduced into the composite fiber component until the second abutment face of the retention portion of the fastening element is in abutment with the first side of the composite fiber component, preferably in abutment in a planar manner. This enables the fastening element to be introduced or pressed into the composite fiber component even in a cold and therefore rigid, hardened state of the composite fiber component, which then becomes partially heated by the heated joining tool and is thereby melted in order to enable first the joining tool and, immediately afterwards, the fastening element to be introduced or pressed in.

To this end, the predeterminable temperature, to which the fastening element and the joining tool are heated, is advantageously predetermined in such a manner that it is above a melting temperature of a thermoplastic matrix of the composite fiber component. This thermoplastic matrix is thereby melted with the hot fastening element while the hot joining tool is pressed through and forms during cooling a positive-locking, materially engaging and/or non-positive-locking connection with the fastening element.

While the hot joining tool with the hot fastening element is pressed through the composite fiber component, the fibers of the composite fiber component in the relevant portion are displaced by the conical or cone-like portion of the joining tool in such a manner that they are located around the sleeve portion of the fastening element and thereby form a new fiber orientation which enables a particularly advantageous force path. In this instance, this displacement of the fibers is particularly advantageously carried out in a non-destructive manner.

In an alternative embodiment, the method may also be integrated in an injection-molding process for forming the composite fiber component so that the joining tool extends through a composite fiber component which has already been heated, for example, a so-called organic metal sheet, and a separate temperature control of the joining tool and/or the fastening element is thus not required. In this embodiment, while the joining tool with the fastening element is pressed through the composite fiber component which is still hot in the injection-molding tool, the fibers of the composite fiber component in the relevant portion are also displaced by the conical or cone-like portion of the joining tool in such a manner that they are located around the sleeve portion of the fastening element and thus form a new fiber orientation which enables a particularly advantageous force path. In this instance, this displacement of the fibers is also carried out in a particularly advantageous manner in a non-destructive manner. In this embodiment of the method, when the composite fiber component is cooled, a positive-locking, materially engaging and/or non-positive-locking connection with the fastening element is also formed.

The fastening element is preferably introduced or pressed into the composite fiber component in such a manner that the second end of the fastening element, which end is directed away from the retention portion, projects beyond the composite fiber component at the second side thereof. It is thereby advantageously possible to shape a portion of the fastening element, which portion projects beyond the composite fiber component at the second side thereof, using an appropriate tool, for example, a mandrel, in such a manner that this portion is angled away from the sleeve portion after the shaping operation and projects beyond an outer diameter of the sleeve portion, that is to say, increases the outer diameter of the sleeve portion. In this manner, the fastening element is also securely interlocked in the composite fiber component, that is to say, is secured in such a positive-locking manner that it cannot be released from the composite fiber component. Preferably, the portion is angled at right-angles away from the sleeve portion by this shaping operation so that, at least when the fastening element extends through the composite fiber component at right-angles, it is in planar abutment with the second side of the composite fiber component. After the shaping operation, the portion preferably forms at least one planar abutment face so that the planar and extensive abutment with the composite fiber component is enabled.

A composite fiber component according to the invention has at least one fastening element described above and is produced using the method described above. Using such a connection, by means of which the fastening element is connected to the composite fiber component, high forces which occur, for example, in vehicle seats in the event of a crash, can be transmitted. The composite fiber component having the at least one fastening element is constructed in an advantageous embodiment as an integral component of such a vehicle seat. Conventional connection elements must either be embedded in the composite fiber component in a complex manner during the production process thereof or be arranged in a screwed manner on the composite fiber component with the fibers of the composite fiber component being destroyed by means of a drilling process.

The composite fiber component according to the invention with the at least one fastening element has a positive-locking, materially engaging and/or non-positive-locking connection which does not destroy fibers between the fastening element and the composite fiber component, a force transmission between the fastening element and composite fiber component in particular being significantly improved.

The composite fiber component, in order to enable the production using the method described above, advantageously has a thermoplastic matrix. The fibers of the composite fiber component may, for example, be carbon fibers, glass fibers and/or natural fibers.

Embodiments of the invention are explained in greater detail below with reference to drawings. The present invention shall be explained in more detail on the basis of the following figures and exemplary embodiments, without the present invention being limited to these. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of a fastening element according to the invention during a joining operation with a joining mandrel;

FIG. 2 is a schematic side view of a fastening element according to the invention after a joining operation has ended;

FIG. 3 is a schematic side view of a fastening element according to the invention after a shaping operation of a portion which projects beyond the composite fiber component has been completed using a mandrel; and

FIG. 4 is a schematic cross-section of a fastening element which is arranged in a composite fiber component in a positive-locking, materially engaging and/or non-positive-locking manner.

### DESCRIPTION OF THE PREFERRED EMBODIMENTS

Components which correspond to each other are given the same reference numerals in all the drawings.

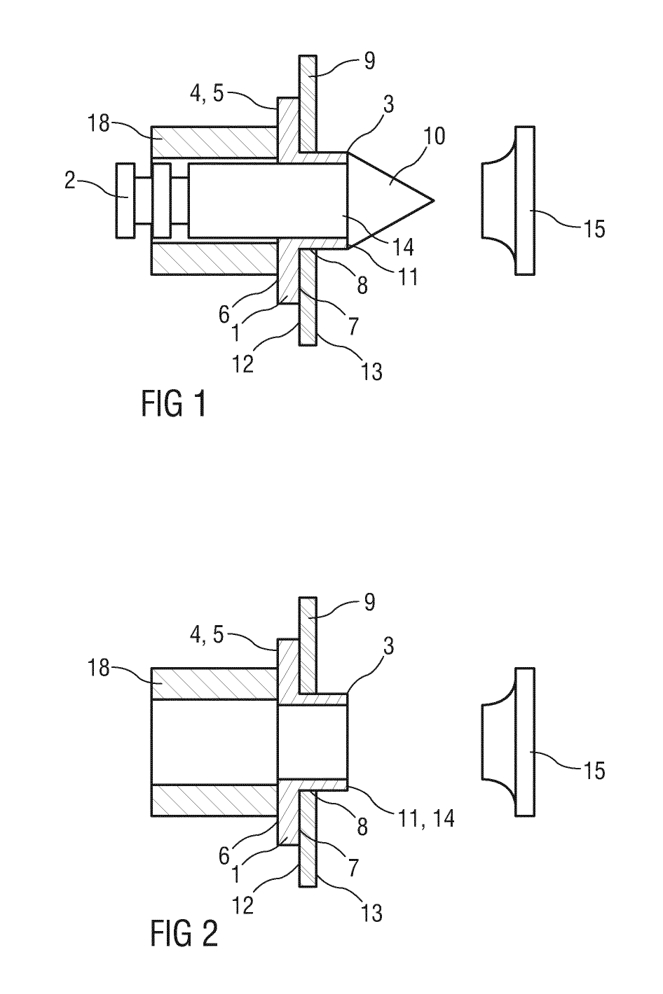

FIG. 1 is a schematic side view of a fastening element 1 according to the invention during a joining operation with a joining tool 2 which is constructed, for example, as a joining mandrel. The joining tool 2 is further referred to as a joining mandrel 2.

The fastening element 1 according to the invention has in the central region thereof a sleeve portion 3. In this sleeve portion 3, a conventional inner thread which is not illustrated in greater detail is formed.

At a first end 4 of the sleeve portion 3, there is arranged a retention portion 5 which is bent at right-angles away from the sleeve portion 3 and which consequently increases an outer diameter of the sleeve portion 3 and forms planar abutment faces 6, 7.

In this instance, a first abutment face 6 faces away from the sleeve portion 3, whilst the second abutment face 7 is directed in the direction of the sleeve portion 3.

The retention portion 5 is preferably constructed in a round manner and may be constructed in a polygonal or oval manner in alternative embodiments.

The fastening element 1 is preferably formed from a metal material and may in the region of the sleeve portion 3 have a surface structure 8 at the outer side. Such a surface structure 8 may, for example, be formed by a graining or a corrugation.

The fastening element 1 is arranged in a composite fiber component 9 by means of the method according to the invention in a positive-locking, materially engaging and/or non-positive-locking manner. The composite fiber component 9 is preferably constructed as a planar semi-finished product of thermoplastic plastics material in which a fabric of glass, carbon and/or aramide fibers or a mixed form thereof is introduced in such a manner that the fibers are completely wetted with thermoplastic plastics material.

Such a composite fiber component 9 may, for example, be a seat structure of a vehicle seat, in particular a backrest rear wall of a so-called organic metal sheet.

In order to arrange the fastening element 1 in the composite fiber component 9 in a positive-locking, materially engaging and/or non-positive-locking manner, a fastening element 1 which is formed according to the invention is placed in a positive-locking manner on a correspondingly formed joining mandrel 2 and the joining mandrel 2 and fastening element 1 are heated to a predeterminable temperature. In this instance, the joining mandrel 2 has a conical or cone-like portion 10 which projects beyond a second end 11 of the fastening element 1, which end is directed away from the retention portion 5.

The joining mandrel 2 and fastening element 1 are introduced or pressed in a heated state through the composite fiber component 9 beginning with the conical or cone-like portion 10 of the joining mandrel 2. In this instance, the predeterminable temperature is above a melting temperature of the thermoplastic matrix of the composite fiber component 9 so that this thermoplastic matrix is melted while it is pressed through the hot fastening element 1 and, on cooling, forms a positive-locking, materially engaging and/or non-positive-locking connection to the fastening element 1, in particular to the surface structure 8 thereof.

There is thereby formed between the fastening element 1 and composite fiber component 9 a particularly robust and resistant positive-locking, materially engaging and/or non-positive-locking connection by means of which large forces can be introduced into the composite fiber component 9.

In this instance, the fastening element 1 is pressed into the composite fiber component 9 in such a manner that the second abutment face 7 of the retention portion 5 of the fastening element 1 is in planar abutment with a first side 12 of the composite fiber component 9.

A length of the fastening element 1 is constructed in this instance in such a manner that it projects beyond the composite fiber component 9 in a joined state at the second side 13 thereof by a predeterminable amount.

While the hot joining mandrel 2 with the hot fastening element 1 is pressed through the composite fiber component 9, the fibers of the composite fiber component 9 in the relevant portion are displaced by the conical or cone-like portion 10 of the joining mandrel 2 in such a manner that they are located around the sleeve portion 3 of the fastening element 1 and thereby form a new fiber orientation which permits a particularly advantageous force path. In a particularly advantageous manner, this displacement of the fibers is carried out in a non-destructive manner in this instance.

FIG. 2 is a schematic side view of a fastening element 1 according to the invention after such a joining operation has been completed. The joining mandrel 2 has in this instance already been removed from the fastening element 1, that is to say, it has been pulled out of the fastening element 1 forward and consequently in the pressing direction used when the joining mandrel 2 is introduced or pressed through the composite fiber component 9 since pulling out in the opposite direction, that is to say, in a backward direction, is not possible, since a diameter of a base face of the conical or cone-like portion 10 of the joining mandrel 2 is as large as an outer diameter of the sleeve portion 3 of the fastening element 1, whereby it is placed on the joining mandrel 2 in a positive-locking manner.

Subsequently, that is to say, after the joining mandrel 2 has been removed, a portion 14 of the fastening element 1 that projects beyond the composite fiber component 9 is shaped with a corresponding shaping tool 15, for example, a mandrel or a shaping die, until the portion 14 is angled away from the sleeve portion 3 at right-angles and thus forms an undercut portion and increases an outer diameter of the sleeve portion 3 and forms planar abutment faces 16, 17.

In this instance, the first abutment face 16 is directed away from the sleeve portion 3 whilst the second abutment face 17 is directed in the direction of the sleeve portion 3.

During the shaping operation, a counter-bearing 18 is in abutment with the first abutment face 6 of the retention portion 5 so that the fastening element 1 is retained in the composite fiber component 9 during the shaping operation and does not slide back. This counter-bearing 18 can also be used in the method step illustrated in FIG. 1 to introduce or press the fastening element 1 and advantageously also the joining mandrel 2 which is in abutment with the conical or cone-like portion 10 thereof with the fastening element 1 into the composite fiber component 9. The counter-bearing is therefore also already in abutment with the fastening element 1 in FIG. 1. Alternatively or additionally, a separate pressing force may also be applied to the joining mandrel 2. For example, when the joining mandrel 2 is introduced or pressed into the composite fiber component 9, the joining mandrel 2 may also be coupled to the counter-bearing 18 by means of formations formed in the joining mandrel 2, so that the pressing force acts both on the fastening element 1 and on the joining mandrel 2. In order to pull the joining mandrel 2 out of the fastening element 1 which is arranged in the composite fiber component 9, the joining mandrel 2 then first has to be released from the counter-bearing 18.

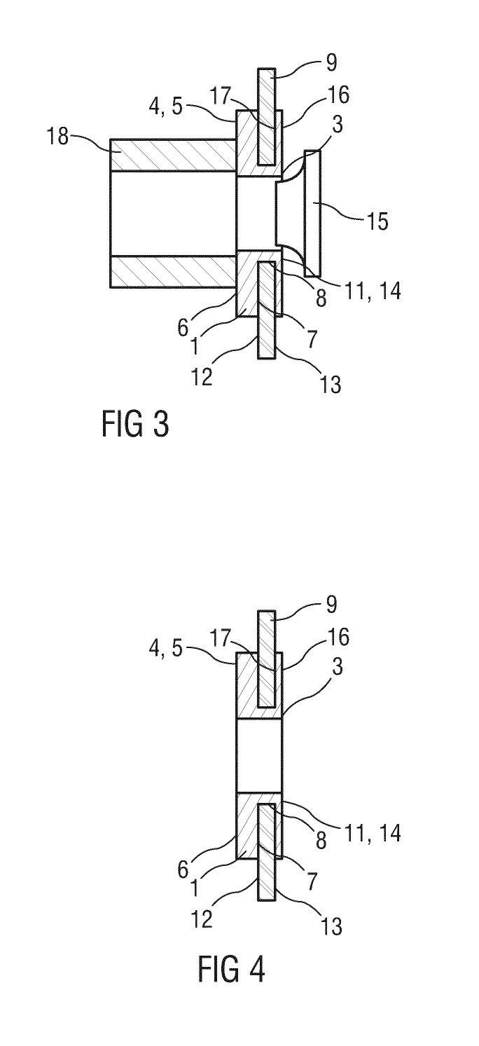

FIG. 3 is a schematic side view of the fastening element 1 according to the invention after such a shaping operation of a portion 14 which projects beyond the composite fiber component 9 has been completed using a mandrel.

FIG. 4 is a schematic cross-section of a fastening element 1 which is arranged in a composite fiber component 9 in a positive-locking, materially engaging and/or non-positive-locking manner.

Using such a connection between the fastening element 1 and composite fiber component 9, high forces which occur, for example, in car seats in the event of a crash, can be transmitted. Conventional connection elements either have to be embedded in the composite fiber component 9 in a complex manner during the production process thereof or have to be arranged on the composite fiber component 9 in a screwed manner with the fibers of the composite fiber component 9 being destroyed by a drilling process. The method according to the invention enables a positive-locking, materially engaging and/or non-positive-locking connection which does not destroy fibers between the fastening element 1 and composite fiber component 9, a force transmission between the fastening element 1 and composite fiber component 9 in particular being significantly improved.

In a particularly advantageous embodiment, the shaping tool 15 may be integrated in an injection-molding tool for shaping the composite fiber component 9 so that the shaping tool 15 extends through a composite fiber component 9 which has already been heated and a separate temperature control of the shaping tool 15 is thus prevented.

While specific embodiments of the invention have been shown and described in detail to illustrate the application of the principles of the invention, it will be understood that the invention may be embodied otherwise without departing from such principles.

1-10. (canceled)

11. A fastening element for positive-locking, materially engaging and/or non-positive-locking arrangement on and/or in a composite fiber component, the fastening element comprising:
a sleeve portion, wherein the sleeve portion has a first end with a retention portion which is angled away from a remainder of the sleeve portion in such a manner that an outer diameter of the fastening element is increased by the retention portion.

12. The fastening element as claimed in claim 11, wherein the sleeve portion has an inner thread.

13. The fastening element as claimed in claim 11, wherein the fastening element is formed from a metal material.

14. The fastening element as claimed in claim 11, wherein the sleeve portion comprises a surface structure at an outer side.

15. A method for mounting a fastening element, the method comprising the steps of:
providing a fastening element comprising a sleeve portion, wherein the sleeve portion has a first end with a retention portion which is angled away from a remainder of the sleeve portion in such a manner that an outer diameter of the fastening element is increased by the retention portion;
placing the fastening element in a positive-locking manner on a joining tool which has a conical or cone-like portion, wherein the conical or cone-like portion projects beyond a second end of the fastening element, which end is directed away from the retention portion, in an axial direction of the sleeve portion of the fastening element, the second end of the fastening element is in abutment with a base face of the conical or cone-like portion and a diameter of the base face of the conical or cone-like portion substantially corresponds to an outer diameter of the sleeve portion of the fastening element; and
introducing or pressing the fastening element and the joining tool into a composite fiber component in such a manner that the conical or cone-like portion of the joining tool extends completely through the composite fiber component from a first side to a second side and the sleeve portion of the fastening element is introduced into the composite fiber component until a second abutment face of the retention portion of the fastening element is in abutment with the first side of the composite fiber component.

16. The method as claimed in claim 15, wherein
the fastening element and the joining tool are heated to a predeterminable temperature before being introduced or pressed into the composite fiber component; and
in the heated state the fastening element and the joining tool are introduced or pressed into the composite fiber component in such a manner that the conical or cone-like portion of the joining tool extends completely through the composite fiber component from the first side to the second side and the sleeve like-portion of the fastening element is introduced into the composite fiber component until the second abutment face of the retention portion of the fastening element is in abutment with the first side of the composite fiber component.

17. The method as claimed in claim 15, wherein the fastening element is introduced or pressed into the composite fiber component in such a manner that the second end of the fastening element, which end is directed away from the retention portion, projects beyond the composite fiber component at the second side thereof.

18. The method as claimed in claim 16, wherein the temperature to which the fastening element and the joining tool are heated is predetermined in such a manner that the temperature to which the fastening element and the joining tool are heated is above a melting temperature of a thermoplastic matrix of the composite fiber component.

19. The method as claimed in claim 17, wherein a portion of the fastening element, which portion projects beyond the composite fiber component at the second side thereof, is shaped in such a manner that this portion is angled away from the sleeve portion after the shaping operation and projects beyond an outer diameter of the sleeve portion.

20. A composite fiber component and the fastening element combination, the combination comprising:
a composite fiber component; and
a fastening element comprising a sleeve portion, wherein the sleeve portion has a first end with a retention portion which is angled away from a remainder of the sleeve portion in such a manner that an outer diameter of the fastening element is increased by the retention portion, the fastening element being mounted to the composite fiber component.

21. The combination as claimed in claim 20, wherein the sleeve portion has an inner thread.

22. The combination as claimed in claim 20, wherein the fastening element is formed from a metal material.

23. The combination as claimed in claim 20, wherein the sleeve portion comprises a surface structure at an outer side.

24. The combination as claimed in claim 20, wherein the fastening element is mounted to the composite fiber component by a method comprising the steps of:
placing the fastening element in a positive-locking manner on a joining tool which has a conical or cone-like portion, wherein the conical or cone-like portion projects beyond a second end of the fastening element, which end is directed away from the retention portion, in an axial direction of the sleeve portion of the fastening element, the second end of the fastening element is in abutment with a base face of the conical or cone-like portion and a diameter of the base face of the conical or cone-like portion substantially corresponds to an outer diameter of the sleeve portion of the fastening element; and
introducing or pressing the fastening element and the joining tool into a composite fiber component in such a manner that the conical or cone-like portion of the joining tool extends completely through the composite fiber component from a first side to a second side and the sleeve portion of the fastening element is introduced into the composite fiber component until a second abutment face of the retention portion of the fastening element is in abutment with the first side of the composite fiber component.

25. The combination as claimed in claim 24, wherein
the fastening element and the joining tool are heated to a predeterminable temperature before being introduced or pressed into the composite fiber component; and
in the heated state the fastening element and the joining tool are introduced or pressed into the composite fiber component in such a manner that the conical or cone-like portion of the joining tool extends completely through the composite fiber component from the first side to the second side and the sleeve like-portion of the fastening element is introduced into the composite fiber component until the second abutment face of the retention portion of the fastening element is in abutment with the first side of the composite fiber component.

26. The combination as claimed in claim 24, wherein the fastening element is introduced or pressed into the composite fiber component in such a manner that the second end of the fastening element, which end is directed away from the retention portion, projects beyond the composite fiber component at the second side thereof.

27. The combination as claimed in claim 25, wherein the temperature to which the fastening element and the joining tool are heated is predetermined in such a manner that the temperature to which the fastening element and the joining tool are heated is above a melting temperature of a thermoplastic matrix of the composite fiber component.

28. The combination as claimed in claim 26, wherein a portion of the fastening element, which portion projects beyond the composite fiber component at the second side thereof, is shaped in such a manner that this portion is angled away from the sleeve portion after the shaping operation and projects beyond an outer diameter of the sleeve portion.
